(19) United States
(12) Patent Application Publication
(10) Pub. No.: US 2024/0171483 A1
(43) Pub. Date: May 23, 2024

(54) KEY PERFORMANCE INDICATOR MONITORING INTERFACE APPARATUS AND METHOD

(71) Applicant: Rakuten Mobile, Inc., Tokyo (JP)

(72) Inventors: Vishvesh TRIVEDI, Tokyo (JP); Anshul BHATT, Tokyo (JP); Dhananjay CHAUBEY, Tokyo (JP); Alok Singh PAWAR, Madhya Pradesh (IN); Manish PATIDAR, Madhya Pradesh (IN)

(21) Appl. No.: 17/757,889

(22) PCT Filed: Apr. 27, 2022
(86) PCT No.: PCT/US22/26442

§ 371 Date: Jun. 23, 2022

(51) Int. Cl. H04L 43/045; H04L 41/22; H04L 43/08; H04L 43/16

(52) U.S. Cl. CPC H04L 43/045; H04L 41/22; H04L 43/08; H04L 43/16

(57) ABSTRACT

A method includes processing a selection to add one or more key performance indicators (KPIs) associated with monitoring a communication network to a KPI monitoring watchlist. The method also includes retrieving a KPI value for each of the one or more KPIs added to the KPI monitoring watchlist from a central data repository. The method further comprises causing the KPI monitoring watchlist to be output to a display such that the KPI value for each of the one or more KPIs added to the KPI monitoring watchlist is arranged in a table having columns and rows, and causing the KPI value(s) to be highlighted in the KPI monitoring watchlist by one of a first color or a second color corresponding to a relationship between the KPI value for each of the one or more KPIs added to the KPI monitoring watchlist and a corresponding preset threshold.

### BACKGROUND

Network operators, network service providers and device manufacturers (e.g., wireless, cellular, etc.) are continually challenged to deliver value and convenience to consumers by, for example, providing compelling communication networks and network services that are dependable and capable of being flexibly constructed, scalable, diverse, and economically operated. To provide such communication networks and network services, network operators, network service providers and device manufacturers often track key performance indicators (KPIs) that are indicative of an operating state of a communication network and/or various network services and/or network devices.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a KPI monitoring and centralized data storage system, in accordance with one or more embodiments.

FIG. 2 is a diagram of a graphical user interface, in accordance with one or more embodiments.

FIG. 3 is a diagram of a graphical user interface, in accordance with one or more embodiments.

FIG. 4 is a diagram of a graphical user interface, in accordance with one or more embodiments.

FIG. 5 is a diagram of a graphical user interface, in accordance with one or more embodiments.

FIG. 6 is a flowchart of a process for selective monitoring and displaying one or more KPI values, in accordance with one or more embodiments.

FIG. 7 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Communication networks and network services are often provided by static or inflexible systems that are difficult to configure, scale, and deploy over various target areas. Dependable provision of communication networks and/or network services that are capable of being flexibly constructed, scalable and diverse is often reliant on the collection, analysis and reporting of information regarding multiple network functions, network services, network devices, etc. that affect the performance, accessibility, configuration, scale, and/or deployment of a communication network, various network functions, network services, and the like.

Network service providers often deploy network monitoring systems that track various key performance indicators (KPIs) of an aspect of a network for determining how well that aspect and/or the network is performing. KPIs are often KPI values and/or trends that are compared to certain thresholds to indicate the relative performance of a communication network, network service, network device, etc. The KPI values are often based on monitoring data referred to herein as system data.

Sometimes, when a KPI value for a certain network function, network service or feature is below a preset threshold, the KPI value may imply that the network is operating normally, whereas when the KPI value is above or equal to the preset threshold, the KPI value implies that the network is operating below expectation, which in turn may indicate that some unexpected event (e.g., a hardware failure, capacity overload, a cyberattack, etc.) has occurred. Accordingly, a series of actions can be carried out by the network monitoring system such as alerting the network operator, shifting a network function from a problematic server to a healthy server, temporarily shutting down the network, or some other suitable action. Of course, depending on the network configuration, a condition in which the KPI value is higher than or equal to a threshold can also indicate that the network is operating normally, while a condition in which the KPI value is below the threshold indicates that the network is operating below expectation. Several other types of threshold configurations are possible as the threshold configurations may vary depending on the needs of a specific user or specific network operator, depending on individual preference, type of KPI being monitored, type of KPI created by a user for monitoring, type of system data that is processed for monitoring a KPI, and the like.

Network operators that coordinate and deploy communication networks that include network services (e.g., hardware, software, etc.) provided by one or more network service providers are reliant on system data supplied to the network operator by the one or more network service providers for monitoring KPIs. Such communication networks often involve network services across multiple domains such as radio area network (RAN), base station subsystem (BSS), platform, core network, etc., various technologies (such as 3G, 4G, LTE, 5G, etc.), multiple locations, various software interfaces, multiple devices, etc. that are proprietary and/or optimized by a specific network service provider.

As the communication network evolves and improves, a single communication network may involve an ever-changing quantity of network service providers for providing network services and/or that are associated with providing network services associated with various aspects of the communication network (e.g., domains, technologies, locations of services, etc.) and, as a result, the state of the communication network may vary dynamically with the addition and/or subtraction of network service providers, a change in one or more network services, etc.

Each network service provider often uses a corresponding monitoring system to monitor performance of the network service(s) provided by that network service provider to gather various system data (e.g., raw data, processed data, and/or pre-processed data provided by a network service provider's monitoring system, pre-processed KPI data provided by the network service providers, etc.) usable by the network operator for determining KPI values indicative of the state of the communication network. The network service providers send the system data to the network operator for monitoring the status of the communication network in consideration of the system data associated with the network service(s) provided by each network service provider. For example, the network operator uses the system data supplied by the network service providers to generate KPI value(s) and/or to evaluate the quality of services provided by each of the network service providers.

Network operators consistently check KPIs, for example, to ensure validity and stability of the communication network. Then, based on a determination that an anomaly occurs in one or more KPIs, take an appropriate action such as making a change in network service providers or network devices that are used to provide one or more network services that are malfunctioning to one or more alternative network service providers and/or one or more alternative network devices to ensure the communication network is operating and available for consumers.

In conventional network monitoring systems, threshold values to which KPIs are compared are often hard-coded by network device manufacturers, network element vendors, network service providers, network service provider monitoring systems, network operators, or the like (“person(s) who hard-coded the thresholds” hereinafter). Changing KPIs and thresholds are often time consuming and troublesome processes for a user monitoring the communication network. To configure the thresholds for KPIs of interest, users that monitor the KPIs often go through a burdensome process which involves first sending a request to the network operator. The network operator then reviews and approves the request, and then sends the request to a specific person who hard-coded the threshold(s) sought to be configured. Users also sometimes want to set multiple thresholds for a KPI so as to determine different conditions for the KPI, which further increases the time and burden of all parties involved when modifications and user customizations are requested for monitoring one or more KPIs in one or more different ways.

Some KPI monitoring systems present KPIs in graphical form to facilitate viewing of the KPI value over time as compared to a preset threshold. But, presenting multiple KPIs in a same graphical display in this way sometimes makes it difficult to comprehend any relationship the KPIs have with any corresponding threshold if, for example, different KPIs have large value differences that are spread far apart from one another. For example, if two KPIs are measured based on values that are far apart from one another in a same graph, the graph may be zoomed out too far to recognize any variations between the KPIs and the thresholds thereof. Similarly, if zoomed out too far, variations in values for one or more KPIs may be recognizable in a graph while values for other KPIs may appear as a straight line. Sometimes, depending on how different the values are for the KPIs that are being monitored, all the KPIs being monitored couple potentially appear as straight lines if the graph is zoomed out far enough to accommodate the values for such KPIs. Users, therefore, often find it difficult to quickly review and/or identify trends and/or variations of the KPIs being monitored, and/or any instance in which a KPI is above or below a threshold from such a graph.

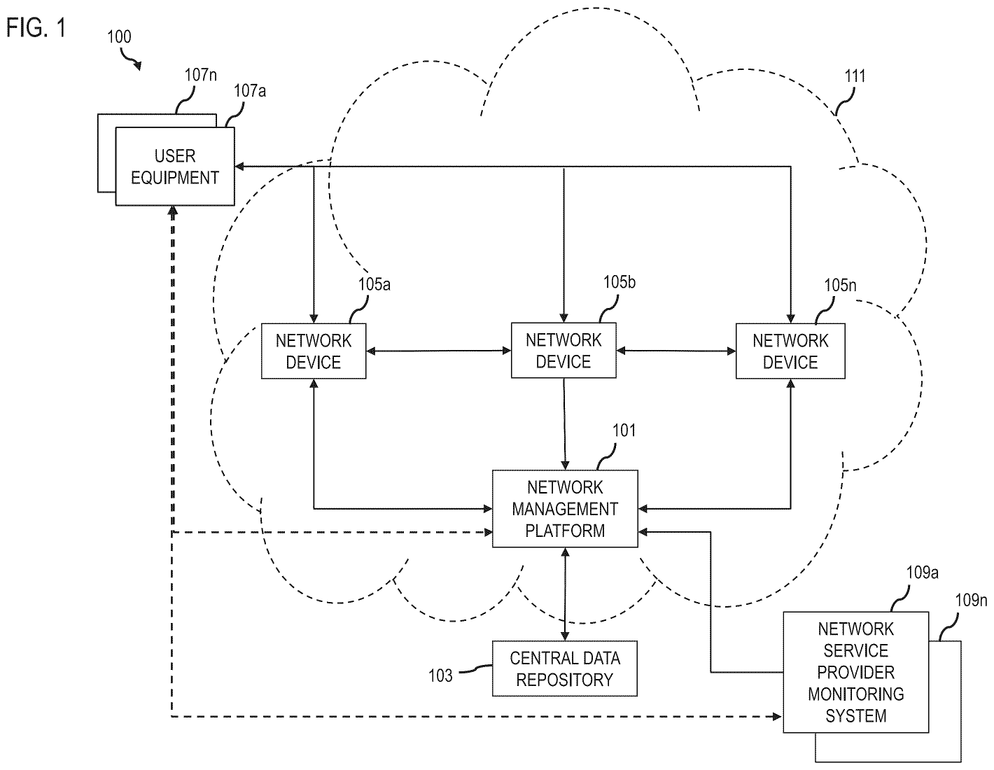

FIG. 1 is a diagram of a KPI monitoring and centralized data storage system 100, in accordance with one or more embodiments.

System 100 makes it possible for a network operator to monitor KPIs associated with a communication network provided by the network operator based on system data received from one or more network service providers that provide network services upon which the communication network is based. In some embodiments, system 100 provides the capability for multiple users to configure one or more thresholds corresponding to one or more KPIs based on each user's own requirement. In some embodiments, system 100 is configured to clearly and simultaneously present the status of multiple KPIs for efficient monitoring by users in a manner than corresponds to a user's needs and/or preferences regardless of how different the values, units, and/or metrics for each KPI being monitored may be from one another.

System 100 comprises a network management platform 101, a central data repository 103, one or more network devices 105a-105n (collectively referred to as network devices 105), and one or more user equipment (UE) 107a-107n (collectively referred to as UE 107). The network management platform 101, the central data repository 103, the one or more network devices 105, and/or the one or more user equipment (UE) 107 are communicatively coupled by way of a communication network 111. In some embodiments, the communication network 111 is orchestrated by the network management platform 101 which combines a plurality of network services provided by one or more network service providers via the network devices 105. In some embodiments, the network management platform 101 is a network orchestrator that implements the communication network 111. In some embodiments, the network management platform 101 is a portion of a network orchestrator that implements the communication network 111.

The network service providers associated with the network services provided have corresponding network service provider monitoring systems 109a-109n (collectively referred to as network service provider monitoring system 109). The network service provider monitoring systems 109 collect system data associated with the network services provided to communication network 111 and send that system data to the network management platform 101 to facilitate monitoring of the state of the communication network 111.

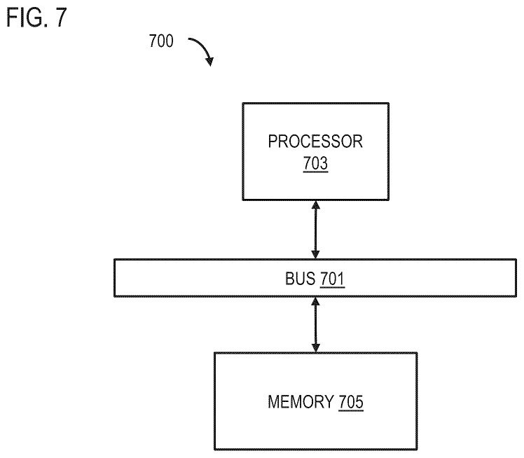

In some embodiments, network management platform 101 comprises a set of computer readable instructions that, when executed by a processor such as a processor 703 (FIG. 7), causes network management platform 101 to perform the processes discussed in accordance with one or more embodiments. In some embodiments, network management platform 101 is remote from the network devices 105. In some embodiments, network management platform 101 is a part of one or more of the network devices 105. In some embodiments, one or more processes the network management platform 101 is configured to perform is divided among one or more of the network devices 105 and a processor remote from the network devices 105. In some embodiments, the network management platform 101 is at least partially implemented by a UE 107.

In some embodiments, central data repository 103 has searchable information stored therein that includes stored system data, rules defining various KPIs, network functions capable of being implemented in the network involving one or more of network usage, timing, connected devices, location, network resource consumption, cost data, example network KPIs, KPI monitoring profiles corresponding to one or more users, KPI evaluation profiles corresponding to one or more users, other suitable elements or information, or a combination thereof. Central data repository 103 is a memory such as a memory 705 (FIG. 7) capable of being queried or caused to store data in accordance with one or more embodiments. In some embodiments, the network management platform 101 and the central data repository 103 together form a network orchestrator that implements the communication network 111. In some embodiments, central data repository 103 comprises multiple data storages. In some embodiments, central data repository 103 is a cluster of cloud servers.

In some embodiments, network management platform 101 generates a graphical user interface that is output to a display by way of a UE 107 or a terminal associated with network management platform 101 for a user (e.g., a network operator, a network administrator, and any personnel which would like to or is responsible to monitor the state of the communication network 111), so as to allow the user to monitor the operating state of the communication network 111. In some embodiments, the user interface is accessible via a web browser such as by way of a website or a web browser plug-in.

The network service provider monitoring system(s) 109 of each of the plurality of network service providers continuously monitor their own corresponding network services and periodically send at predetermined times (e.g., every 5 minutes, every 15 minutes, every 30 minutes, etc.) the monitored system data to the network management platform 101. In some embodiments, the network management platform 101 causes the monitored system data to be stored in the central data repository 103. In some embodiments, the central data repository 103 is controlled by the network operator.

The system data is communicated from the network service provider monitoring systems 109 to the network management platform 101 via one or more of a wireless communication channel, a wired communication channel, enhanced messaging service (EMS), email messaging, data packet transmission, or some other suitable type of data transmission which is optionally the same or different among the plurality of network service providers.

In some embodiments, the network management platform 101 continuously monitors the system data received from the network service provider monitoring system(s) 109 by processing received system data that is stored in the central data repository 103.

In some embodiments, when a user (e.g., a network operator, a network service provider, and/or any personnel that would like to or is responsible to monitor the system) wants to monitor one or more KPIs, the network management platform 101 makes it possible for a user to access to the centralized platform via a UE 107. The network management platform 101 determines the identity of the user based on user credentials, access device, or some other suitable manner, and provides a graphical user interface to the user via a UE 107. In some embodiments, the network management platform 101 limits functions available to the user by way of the graphical user interface depending on the type of user (e.g., a regular user may have access to fewer functions than a VIP user, a network administrator may have access to all functions, etc.).

In use, when a network operator wants to monitor one or more KPIs, the network operator accesses the network management platform 101 by way of the network operator's terminal (e.g., a UE 107 having connectivity to the communication network 111).

After authentication and authorization based on receiving and processing user credentials (e.g., user ID and password, etc.), the network management platform 101 retrieves a user profile of the network operator (e.g., which may be stored in the central data repository 103 or some other suitable memory or database having connectivity to system 100), accesses the central data repository 103 to determine (based on the user profile) which stored system data is related to the network operator, and then generates and presents a list of KPIs that are capable of being viewed by the user by way of the graphical user interface based on the determined stored system data related to the network operator.

In some embodiments, network management platform 101 is configured to enable multiple users to select one or more KPIs that are to be monitored in each user's preferred manner, to map a status of the selected KPI(s) to a selected color based on each user's individual preference, to present KPI values for the user-selected KPI(s) with the KPI value of each selected KPI being highlighted according to the user-selected color scheme, and to update the highlighting color of the KPI value(s) in real-time according to any changes in status of the selected KPI(s) based on the user-selected color scheme.

In some embodiments, network management platform 101 enables a user to select one or more target KPIs based on a user's desired information (e.g., vendors, type of domains, type of technologies, type of KPI, type of busy hour, or some other suitable information) and allows the user to select and set a desired color code as corresponding to one or more desired conditions associated with the selected target KPI(s). The specified the one or more conditions are applied by the network management platform 101 to determine a relationship between the KPI value(s) for the selected KPI(s) with respect to a preset threshold.

Network management platform 101 generates and outputs a graphical user interface that is configured to receive various parameters associated with selecting the one or more target KPIs, assigning one or more conditions based upon which a relationship status of the one or more KPIs with respect to a preset threshold may be determined, setting the preset thresholds(s), assigning a color code to the one or more conditions, etc.

Subsequently, network management platform 101 causes the input parameters to be saved as a user's monitoring profile. In some embodiments, the monitoring profile is stored in database 103 or some other suitable memory.

Network management platform 101 is configured to retrieve a user's selected KPI(s) and generate a KPI monitoring watchlist that presents the selected KPIs to the user by way of a display of a UE 107, for example.

Network management platform 101 causes a relationship of each KPI included in the KPI monitoring watchlist at a time point in the KPI monitoring watchlist to be highlighted with an associated color defined in the monitoring profile. In some embodiments, network management platform 101 continuously retrieves KPI values from the central data repository 103 for the selected KPIs and updates the color highlighting the KPI values based on the monitoring profile.

In some embodiments, network management platform 101 creates and stores a monitoring profile for each of the selected KPIs, continuously obtains KPI values for the user-selected KPI(s) from the central data repository, compares the KPI value(s) to the preset threshold(s) according to the conditions specified by the user in the monitoring profile, determines a relationship of the KPI value(s) with respect to the preset thresholds based on the conditions at a time corresponding to a moment the KPI value is/was indicative of the state of the communication network, and causes the KPI value(s) to be included in the KPI monitoring watchlist such that the KPI value(s) are highlighted in the displayed KPI monitoring watchlist in accordance with the colors that were mapped to the conditions defined in the monitoring profile.

In some embodiments, when a user (e.g., a network operator, a network vendor, and any personnel which would like to or is responsible to monitor one or more KPIs) wants to monitor one or more KPIs, the user may access the network management platform 101 by way of a corresponding UE 107 regardless of the physical location of the user. The network management platform 101 then determines the identity of the user based on user credentials, device information, location information, internet protocol address, or some other suitable identifier, and provides the graphical user interface to the user.

The graphical user interface includes a KPI monitoring watchlist that includes one or more KPIs that are being monitored by the user having previously been selected for monitoring, and/or one more functional elements to facilitate adding one or more KPIs to the KPI monitoring watchlist, removing one or more KPIs from the KPI monitoring watchlist, editing a monitoring profile associated with one or more of the KPIs included in the KPI monitoring watchlist, adding a monitoring profile to the KPI monitoring watchlist regarding one or more KPIs included in the KPI monitoring watchlist and/or one or more KPIs capable of being added to the KPI monitoring watchlist, removing one or more monitoring profiles for one or more of the KPIs included in the monitoring watchlist, a scroll-bar to navigate through the KPI monitoring watchlist, etc.

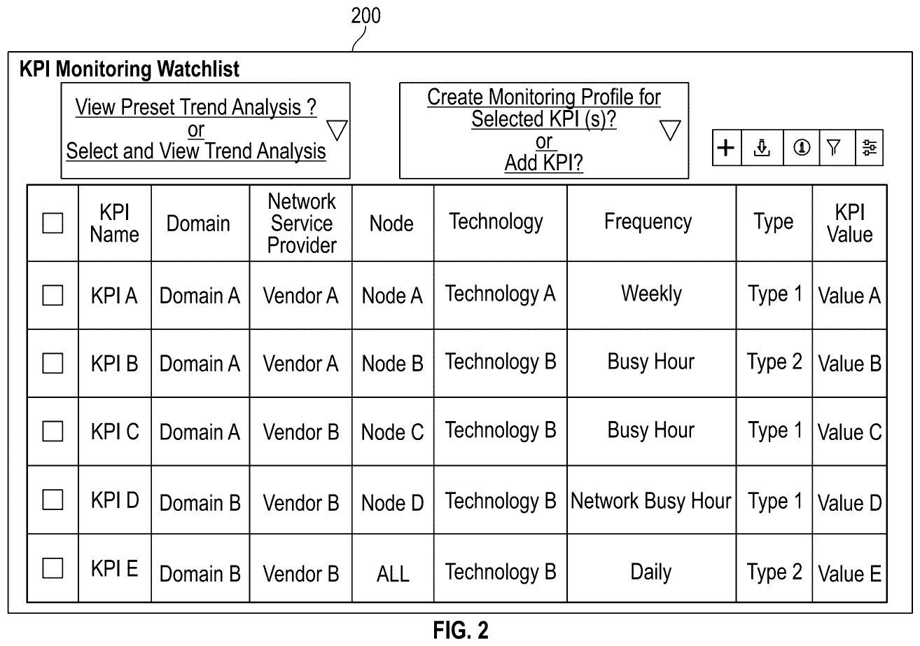

FIG. 2 is a diagram of a graphical user interface 200, in accordance with one or more embodiments. Network management platform 101 is configured to cause graphical user interface 200 to be output to a display.

Graphical user interface 200 is a KPI monitoring watchlist. Graphical user interface 200 includes a list of KPIs that selected to be monitored by a user. Graphical user interface 200 includes the selected KPIs arranged in a table having columns and rows. Information regarding each KPI (included in the list of KPIs) includes the name of the KPI, a domain name, network service provider name, node name, technology type, frequency of the KPI value being monitored, a computation type, and a KPI value. In some embodiments, alternative information is included in the list of KPIs. In some embodiments a greater quantity of columns is included in the KPI monitoring watchlist. In some embodiments, a lesser quantity of columns is included in the KPI monitoring watchlist. In some embodiments, the KPI value, for example, is excluded from the KPI monitoring watchlist. In some embodiments, graphical user interface 200 includes an edit icon that facilitates a user-selection to add or remove columns from the KPI monitoring watchlist. In some embodiments, graphical user interface 200 includes a filter icon that facilitates a user selection to reduce a quantity of KPIs displayed at any given time by way of graphical user interface 200 based on a user selection to show KPIs associated with a selected domain, KPI group, network service provider, technology, computation type, or some other suitable basis.

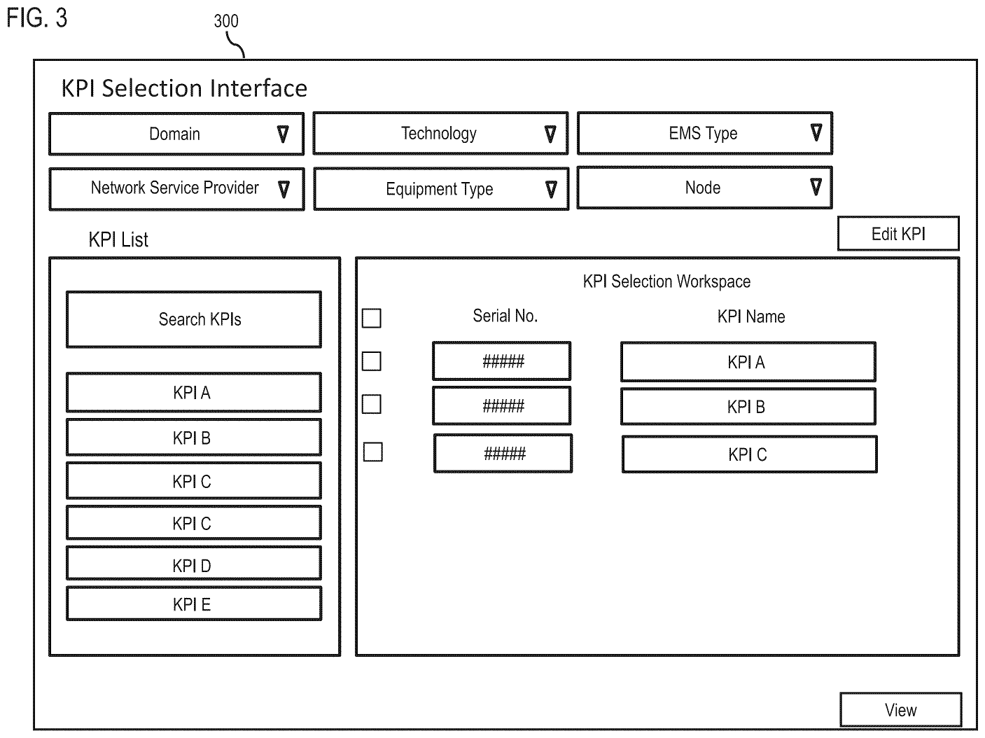

Graphical user interface 200 includes an option to add additional KPIs to the KPI monitoring watchlist. In some embodiments, graphical user interface 200 facilitates adding a KPI to the KPI monitoring watchlist by selecting “add KPI” in a drop-down box and selecting a “+” sign. In some embodiments, some other suitable method is used to cause a KPI to be added to the KPI monitoring watchlist. Network management platform 101 causes graphical user interface 300 (FIG. 3) to be displayed based on a selection to add a KPI to the KPI monitoring watchlist.

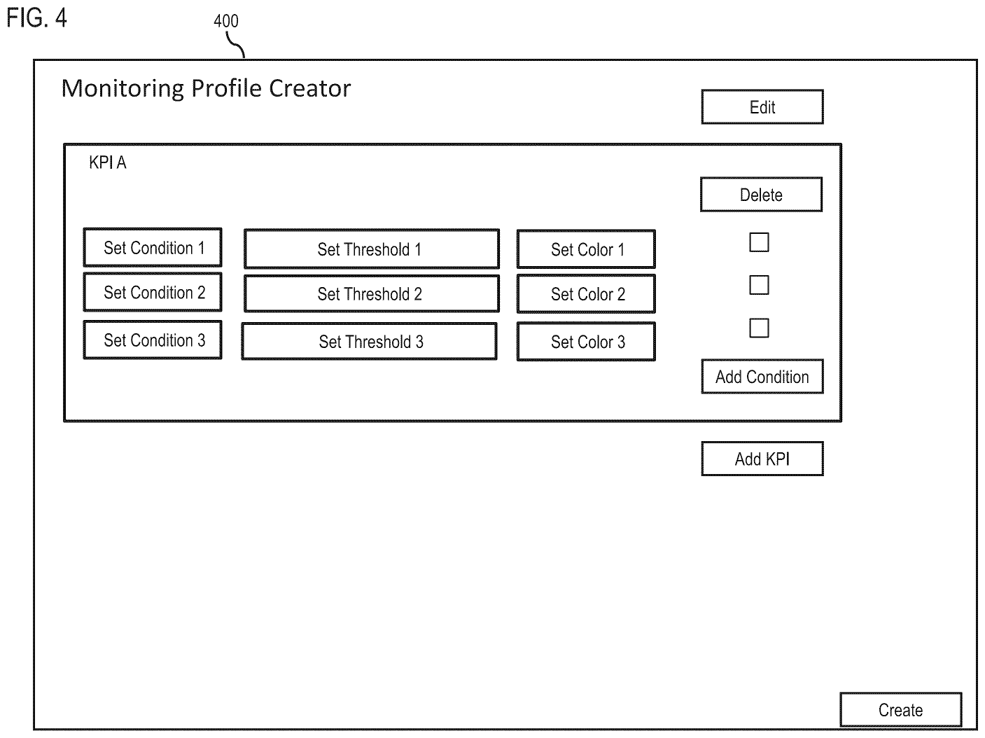

In some embodiments, graphical user interface 200 includes an option to create a KPI monitoring profile based on a selection of one or more KPIs included in the KPI monitoring watchlist. In some embodiments, graphical user interface 200 facilitates creating a KPI monitoring profile by selecting “create KPI monitoring provide for selected KPI(s)” in a drop-down box and selecting a “+” sign. In some embodiments, some other suitable method is used to cause a KPI to be added to the KPI monitoring watchlist. For example, based a selection of one or more of KPI A, KPI B, KPI C, etc. in graphical user interface 200, and a selection to create a KPI monitoring profile for the selected KPI(s), network management platform 101 causes graphical user interface 400 (FIG. 4) to be displayed.

In some embodiments, network management platform 101 causes a color scheme associated with the one or more KPIs (for which a monitoring profile is created via graphical user interface 400) to be applied in the KPI monitoring watchlist. For example, if a monitoring profile is created for KPI A, and that monitoring profile indicates that a condition of KPI A being greater than a preset threshold is green and a condition of KPI A being less than the preset threshold is red, one or more of the entire row in the KPI monitoring watchlist for KPI A, the name of KPI A, the value of KPI A, or some other option is caused to be colored green or red based on a determined relationship of the KPI value (Value A in this example) of KPI A at the time the user is viewing KPI monitoring watchlist.

In some embodiments, if a monitoring profile is created for KPI B, for example, network management platform 101 causes the row, the name of KPI B, the value of KPI B, etc., to be highlighted in accordance with the color scheme assigned to KPI B.

In some embodiments, a monitoring profile may be made for each KPI individually. In some embodiments, a monitoring profile may be made for multiple KPIs. For example, in one monitoring profile, multiple KPIs may be designated by a user to have a same color scheme for certain determined relationships of the corresponding KPI values to any preset thresholds. In some embodiments, individual monitoring profiles may have the same color schemes. In some embodiments, monitoring profiles for different KPIs may have different color schemes. For example, if green indicates that KPI A is greater than a preset threshold, green may also indicate that KPI B is less than a preset threshold. In some embodiments, KPI A and KPI B may be comparing similar things with respect to the operating state of the network, such as node availability time. In some embodiments, KPI A and KPI B may compare completely different things such as Node A availability time and quantity of users connected to the network via Node A within a period of time.

In some embodiments, the colors scheme may be any combination of colors, shades, patterns, flashing or blinking alerts, etc. that are selected by a user via graphical user interface 400 to provide a user with the capability to quickly identify the status of any KPI included in the KPI monitoring watchlist having a monitoring profile. In some embodiments, the quantity of conditions that the user may add to the monitoring profile as a basis for comparing the KPI value at a given time to a preset threshold may be any quantity that the user may select for identifying a particular relationship that the user would like to see. For example, a user may add three conditions for one KPI and 10 conditions for a different KPI. In some embodiments, a user may even track a same KPI multiple different ways such that a first color scheme is applicable to some conditions the user set for KPI A and a different color scheme is applicable for some other conditions the user set for KPI A.

In some embodiments, network management platform 101 facilitates creating a monitoring profile that has multiple conditions which compare the KPI values to a single preset threshold. In some embodiments network management platform 101 facilitates creating a monitoring profile that has multiple conditions for which each condition is compared to a different preset threshold to facilitate determining a relationship that is of interest to a user and can thus be assigned a color scheme.

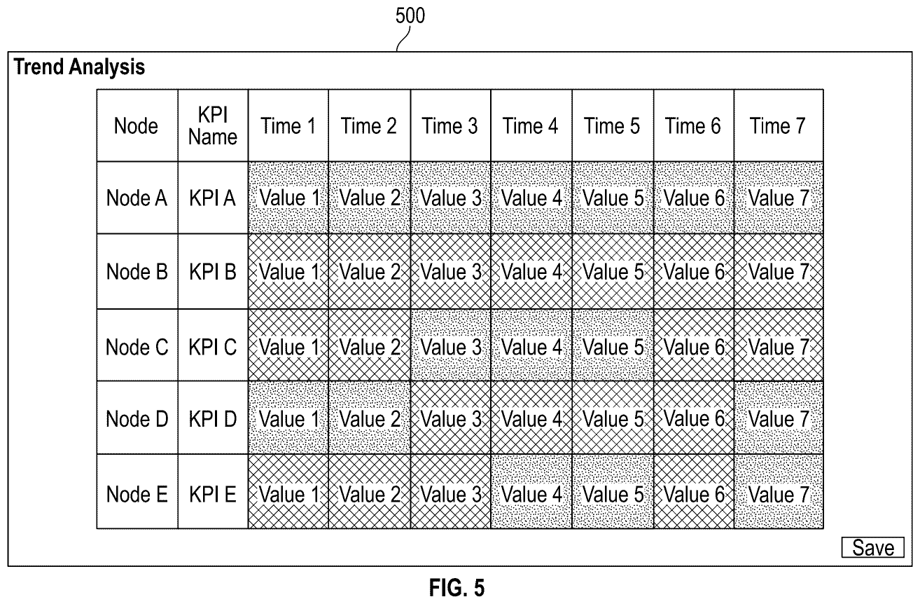

In some embodiments, graphical user interface 200 includes an option to view a preset trend analysis or to select and view an ad hoc trend analysis. In some embodiments, a user may create a monitoring profile that includes one or more KPIs and network management platform 101 causes KPI values for the one or more KPIs to be included in a trend analysis view that includes the KPI values for the one or more KPIs over time. In the trend analysis view, the KPI values are caused to be presented in accordance with the color scheme (e.g., highlighted according to the color scheme, etc.) that is assigned to the condition-based relationships that are set when creating the monitoring profile. Similarly, in some embodiments, graphical user interface 200 facilitates selecting one or more of the KPIs included in the KPI monitoring watchlist and viewing the trend analysis on an ad hoc basis. Graphical user interface 500 (FIG. 5) includes an example of a trend analysis that is generated and capable of being viewed based on a user input received to view a preset trend analysis or to select and view a trend analysis in graphical user interface 200. In some embodiments, graphical user interface 500 makes it possible for a user to save the ad hoc trend analysis as a preset trend analysis for future access by way of graphical user interface 200. In some embodiments, a trend analysis is caused to be added to graphical user interface 200 such that a plurality of historical KPI values are added to the KPI monitoring watchlist, the KPI values are each provided in a corresponding column having a date and/or time, for example, to the right side of the KPI monitoring watchlist, and graphical user interface is scrollable to view the additional KPI values over time.

In some embodiments, graphical user interface 200 facilitates a user editing one or more of the KPIs added to the KPI monitoring watchlist. For example, a user may select a KPI and trigger the edit button, double click a KPI, or by way of some other suitable action. Based on a user instruction to edit a selected KPI, network management platform 101 causes a graphical user interface to be displayed that includes input windows comprising parameter options for editing, adding, and/or replacing portions of the KPI that is to be monitored. In some embodiments, a user may delete a KPI from the KPI monitoring watchlist by dragging and dropping the KPI out of the KPI selection workspace, dragging a KPI to a recycle bin, for example, highlight the KPI and hitting delete, right clicking and deleting the KPI, or by some other suitable action.

FIG. 3 is a diagram of a graphical user interface 300, in accordance with one or more embodiments. Network management platform 101 is configured to cause graphical user interface 300 to be output to a display.

Graphical user interface 300 is a KPI selection interface. Graphical user interface 300 is caused to be displayed based on a user input to add one or more KPI(s) to the KPI monitoring watchlist in graphical user interface 200 (FIG. 2).

Graphical user interface 300 includes a list of KPIs that are capable of being monitored by a user. Graphical user interface 300 facilitates selecting one or more of the KPIs included in the list of KPIs for monitoring. In some embodiments, the selection to view one or more KPIs included in the list of KPIs is made by dragging and dropping one or more KPIs from the list of KPIs to a KPI selection workspace included in graphical user interface 300. In some embodiments, the selection to view one or more KPIs included in the list of KPIs is made by doubling clicking, right clicking, or by some other suitable action, which causes one or more KPIs selected from the list of KPIs to populate the KPI selection workspace in the graphical user interface

Graphical user interface 300 includes a plurality of parameter input fields that are usable to narrow the quantity of KPIs included in the list of KPIs. Network management platform 101 is configured to filter the KPIs included in the list of KPIs by processing parameter selection inputs received by way of the parameter input fields included in graphical user interface 300.

Graphical user interface 300 includes parameter input fields configured to receive user inputs indicating a domain, a technology, a network service provider name, an element management system type that manages various types of one or more network elements within a telecommunication management network (TMN), and an equipment type. In some embodiments, graphical user interface 300 additionally or alternatively includes parameter input fields configured to receive user inputs indicating a node name or some other usable information identifiable in the system data upon which the KPIs are determined and based upon which the list of KPIs is capable of being narrowed. Graphical user interface 300 includes a search KPI input field configured to receive a user input for facilitating a search for KPIs included in the list of KPIs that match a user input word and/or number search. In some embodiments one or more of the parameter input fields is configured to receive a textual input from a user. In some embodiments, one or more of the parameter input fields or the search KPI input field facilitates selecting a parameter, or a word/number that is associated with a KPI included in the KPI list, by way of a drop-down box, radio button(s), check-box(es), or some other suitable manner.

After a user has selected one or more KPIs, the user may then select a view option, a “next” option, or some other suitable instruction icon to cause the network management platform 101 to advance to a next step in adding the selected KPI(s) to the KPI monitoring watchlist.

In some embodiments, graphical user interface 300 facilitates a user editing one or more of the KPIs added to the KPI selection workspace. For example, a user may select a KPI and trigger an edit button, double click the KPI, or by way of some other suitable action. Based on a user instruction to edit a selected KPI, network management platform 101 causes a graphical user interface to be displayed that includes input windows comprising parameter options for editing, adding, and/or replacing portions of the KPI that is to be monitored. In some embodiments, a user may delete a KPI from the KPI selection workspace by dragging and dropping the KPI out of the KPI selection workspace, dragging a KPI to a recycle bin, for example, highlight the KPI and hitting delete, or by some other suitable action.

FIG. 4 is a diagram of a graphical user interface 400, in accordance with one or more embodiments. Network management platform 101 is configured to cause graphical user interface 400 to be output to a display.

Graphical user interface 400 is a monitoring profile creator interface that is caused to be displayed based on a selection to create a monitoring profile in graphical user interface 200 (FIG. 2).

Graphical user interface 400 comprises input fields configured to receive user inputs setting a condition for comparing a KPI value for the one or more KPIs that has been selected to have a monitoring profile created to a preset threshold, user inputs setting the preset threshold(s), and user inputs setting color schemes corresponding to relationship(s) that are determined based on the conditions and a comparison of the KPI value(s) to the preset threshold(s).

In some embodiments, the input field(s) for receiving user inputs indicating a condition comprise one or more of a drop-down box with fixed options or a text box configured to receive a user input indicating the condition. In some embodiments, the condition options comprise greater than, less than, equal to, not equal to, within a tolerance range, or some other suitable pre-established condition or a customizable option entered into the set condition input field by a user.

In some embodiments, the input field(s) for receiving user inputs indicating the preset threshold to which a KPI value is to be compared comprise a dropdown box with pre-established threshold options that network management platform 101 determines are relevant to the KPI(s) for which the monitoring profile is being created or a text box configured to receive a user input that indicates a user-selected threshold, a system code for an established threshold or filter that is known to the user and stored in central data repository 103, for example, or some other suitable input.

In some embodiments, the input field(s) for receiving user inputs indicating the color that is to be used in the KPI monitoring watchlist and/or to view a trend analysis comprise a drop-down box with selectable colors to highlight the KPI values or other suitable information in the KPI monitoring watchlist and/or trend analysis view. In some embodiments, the user inputs indicating the color that is to be used in the KPI monitoring watchlist and/or to view a trend analysis further comprise an option to use a pattern for highlighting the KPI values or other suitable information such as, for example, polka dots or stripes. In some embodiments, the user inputs indicating the color that is to be used in the KPI monitoring watchlist and/or to view a trend analysis optionally comprise an option to cause the highlighting color and/or pattern to flash in the KPI monitoring watchlist and/or the trend analysis view based on the user-selected condition based relationship.

To assist in understanding the capability of mapping a color scheme to the condition-based relationships when creating the monitoring profiles, consider an example in which the condition of “KPI greater than the preset threshold value” is mapped to a “red” color, the condition of “KPI equal to the preset threshold value” is mapped to a “green” color, and the condition of “KPI less than the preset threshold value” is mapped to a “brown” color. Another exemplary color scheme may be one in which the condition of “KPI equal to the preset threshold value” is not mapped to a color, whereas the condition of “KPI greater than the preset threshold value” is mapped to a “red” color and the condition of “KPI less than the preset threshold value” is mapped to a “green” color, or some other suitable user-selected color correspondences.

In some embodiments, the monitoring profile may be created as having as little as one condition, two conditions, three conditions, or any other suitable quantity of conditions by adding, deleting, or simply not mapping a color to a condition or threshold. In some embodiments, the color options may be any color of the rainbow, blend thereof, shade of color, brightness, animation or transition of color, or some other suitable option to attract a user's attention to the state of the KPI in a the KPI monitoring watchlist and/or the trend analysis view. In some embodiments, graphical user interface 400 facilitates adding additional KPIs to the monitoring profile. In some embodiments, additional KPIs may be added to facilitate setting condition-based relationships and corresponding color schemes. In some embodiments, graphical user interface 400 optionally includes an option to apply the same color schemes to additional KPIs that are added to the monitoring profile. In some embodiments, graphical user interface 400 facilitates setting conditions, thresholds and/or color schemes independently for each KPI included in the KPI monitoring profile and/or each condition that is added to each KPI portion of the KPI monitoring profile.

In some embodiments, adding another KPI optionally causes a selectable option in the input field for setting the preset threshold for at least one of the KPI portions of the monitoring profile to select another one of the KPIs included in the KPI monitoring profile as the threshold to which the KPI value of one of the KPIs is compared. For example, if KPI A and KPI B are each monitoring an up-time of two different nodes, the threshold to which the values for KPI A may be compared is the values for KPI B as the same or at some other offset time, for example.

After creating the monitoring profile, network management platform 101 causes the monitoring profile to be saved in central data repository 103 and applied based on a user interaction with a “create” icon, an “apply” icon, a “save” icon, by hitting “ctrl+S” on a keyboard, or by some other suitable action. Similarly, the user may optionally edit the created monitoring profile (e.g., by selecting a dedicated “edit” icon, by double clicking an existing monitoring profile, etc.) or delete the monitoring profile.

FIG. 5 is a diagram of a graphical user interface 500, in accordance with one or more embodiments. Network management platform 101 is configured to cause graphical user interface 400 to be output to a display.

Graphical user interface 500 is a trend analysis view of a plurality of KPIs triggered by a selection to view a preset trend analysis or an ad hoc trend analysis in graphical user interface 200 (FIG. 2).

Based on the user input to view a preset trend analysis or an ad hoc trend analysis in graphical user interface 200, network management platform 101 retrieves the KPI values for the time period indicated in the trend analysis view from the central data repository 103. The network management platform 101 then retrieves the monitoring profile(s) associated with each individual KPI selected for inclusion in the trend analysis. In some embodiments, the monitoring profiles in the central data repository 103, or in some other memory external to the central data repository 103. Network management platform then generates a tabular view of the KPIs, the KPI values and the corresponding times for the KPI values.

Network management platform 101 then compares each of the retrieved KPI values to the preset threshold(s) included in the corresponding monitoring profile(s), determines which the relationship each KPI value has with respect to the preset threshold(s) according to the condition(s) in the monitoring profile(s), and causes the KPI values in graphical user interface 500 to be colored in a manner that corresponds to the color schemes set in the monitoring profile(s) at each time point. In this manner, for example, a user may readily recognize that some KPIs are showing values that are greater than a threshold, whereas other KPIs are showing values that are less than a threshold, identify any patterns or changes with respect to other KPIs and/or times, without having to view a complete graph of the KPI values that may not readily demonstrate the patterns, changes, or trends in the various KPIs over time because the nuances are difficult to see when the multiple KPIs are shown in a single graphical view.

In some embodiments, the trend analysis view shown in graphical user interface 500 is a sub-interface that is launched from graphical user interface 200. In some embodiments, the trend analysis view shown in graphical user interface 500 is added to graphical the KPI monitoring watchlist in graphical user interface 200.

In some embodiments, the network management platform 101 is configured to continuously retrieve the KPI values for the selected KPI from the central data repository 103, and continuously update the list with the KPI status at different time points as time progresses. In some embodiments, the continuous updating provides real-time KPI status monitoring features, wherein the status color indicating the relationship of the KPI value being monitored to the preset threshold(s) are updated in real-time when the associated KPI values change and the network management platform 101 determines the relationship has changed based on the conditions in the monitoring profile.

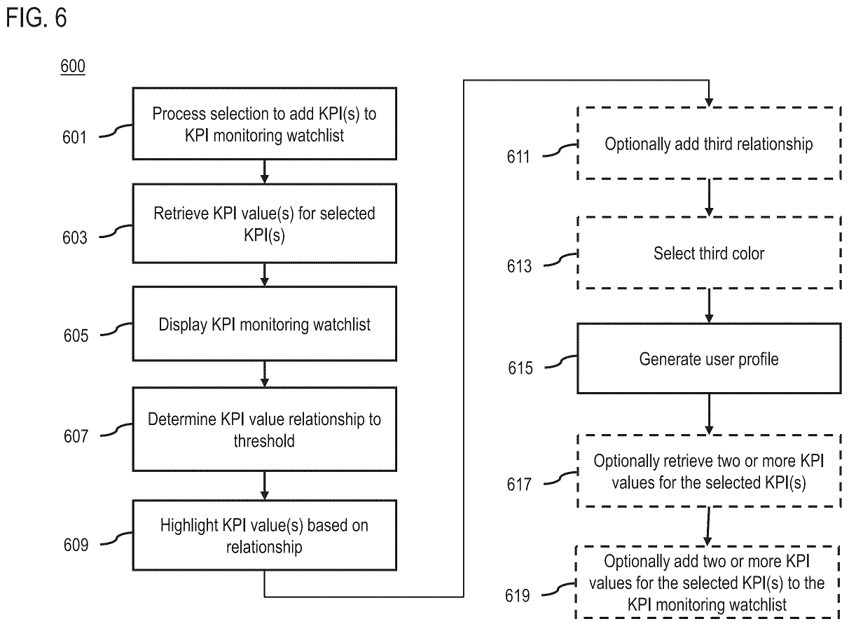

FIG. 6 is a flowchart of a process 600 for selective monitoring and displaying of one or more KPI values, in accordance with one or more embodiments. In some embodiments, the network management platform 101 (FIG. 1) performs the process 500.

In step 601, a selection is processed to add one or more KPIs associated with monitoring a communication network to a KPI monitoring watchlist.

In step 603, a KPI value is retrieved for each of the one or more KPIs added to the KPI monitoring watchlist from a central data repository.

In step 605, the KPI monitoring watchlist is caused to be output to a display such that the KPI value for each of the one or more KPIs added to the KPI monitoring watchlist is arranged in a table having columns and rows. Each of the one or more KPIs added to the KPI monitoring watchlist is arranged in one of the rows in the table. The KPI value for each of the one or more KPIs added to the KPI monitoring watchlist is in a corresponding row of the table under a header corresponding to a time at which the KPI value corresponds to an operating status of the communication network.

In step 607, the KPI value for each of the one or more KPIs added to the KPI monitoring watchlist is compared to a preset threshold corresponding to each of the one or more KPIs added to the KPI monitoring watching to determine a relationship between the KPI value for each of the one or more KPIs added to the KPI monitoring watchlist and each preset threshold.

In step 609, the KPI value for each of the one or more KPIs added to the KPI monitoring watchlist is caused to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold.

In some embodiments the relationship between the KPI value for each of the one or more KPIs added to the KPI monitoring watchlist and each preset threshold is based on a first user input received by way of a graphical user interface defining the relationship with respect to each corresponding preset threshold and a second user input indicating the first color corresponding to the relationship.

In some embodiments, the relationship is one of greater than or less than, and the first color and the second color facilitate a visual representation of the relationship between the KPI value for each of the one or more KPIs added to the KPI monitoring watchlist and each preset threshold at the time indicated in the header of the KPI monitoring watchlist such that the first color corresponds to the relationship being greater than and the second color corresponds to the relationship being less than. In some embodiments, the KPI value is capable of being highlighted by a third color indicative of a third relationship. In some embodiments, the third relationship is equal to, or some other suitable relationship. In some embodiments, the KPI value is capable of being highlighted by some other color corresponding to whatever relationship the user defines.

In some embodiments, the relationship is one of a first relationship or a second relationship. The first relationship is defined by a first user input received by way of a graphical user interface, and the second relationship is defined by a second user input received by way of the graphical user interface. The first color is selected by a third user input received by way of the graphical user interface, and the second color is selected by a fourth user input received by way of the graphical user interface. The first color corresponds to the first relationship, and the second color corresponds to the second relationship.

In some embodiments, the first relationship is a range encompassing values greater than and less than a corresponding preset threshold, the second relationship is greater than a high end of the range. In some embodiments, a third relationship is, for example, less than a low end of the range.

In some embodiments, two or more KPIs are added to the KPI monitoring watchlist, each of the two of more KPIs have identical relationships and first color and second color correspondences, and each of the two of more KPIs have different preset thresholds.

In some embodiments, two or more KPIs are added to the KPI monitoring watchlist, each of the two of more KPIs have different relationships and first color and second color correspondences, and each of the two of more KPIs have different preset thresholds.

In optional step 611, an instruction to add a third relationship capable of being determined based on the comparison is processed. The instruction to add the third relationship is received by way of a fifth user input received by way of the graphical user interface.

In optional step 613, a sixth user input received by way of the user graphical user interface to select a third color corresponding to the third relationship is processed. In some embodiments, the third relationship is different from the first relationship and the second relationship.

In step 615, a user profile is caused to be generated based on the user inputs received defining the relationships and the corresponding colors.

In optional step 617, two or more KPI values for each of the one or more KPIs added to the KPI monitoring watchlist are retrieved from the central data repository. The two or more KPI values comprise at least one historical KPI value corresponding to a prior time at which the KPI value(s) correspond to the operating status of the communication network and most recent KPI value(s) corresponding to the operating status of the communication network.

In optional step 619, the two or more KPI values for each of the one or more KPIs added to the KPI monitoring watchlist are caused to be included in the KPI monitoring watchlist according to the times at which the two or more KPI values correspond to the operating status of the communication network.

In some embodiments, the communication network is continuously monitored such that KPI values for the one or more KPIs are added to the KPI monitoring watchlist as time progresses from a start time to an end time, and the relationship for each KPI value included in the KPI monitoring watchlist is compared to each preset threshold and the relationship is identified in the KPI monitoring watchlist for each KPI value at each time by way of the first color, the second color, the optional third color, and/or any other optional quantity of colors associated with the relationships for each of the one or more KPIs.

FIG. 7 is a functional block diagram of a computer or processor-based system 700 upon which or by which an embodiment is implemented.

Processor-based system 700 is programmed to selectively monitor and display one or more KPI values, as described herein, and includes, for example, bus 701, processor 703, and memory 705 components.

In some embodiments, the processor-based system is implemented as a single “system on a chip.” Processor-based system 700, or a portion thereof, constitutes a mechanism for performing one or more steps of selective monitoring and displaying of one or more KPI values.

In some embodiments, the processor-based system 700 includes a communication mechanism such as bus 701 for transferring and/or receiving information and/or instructions among the components of the processor-based system 700. Processor 703 is connected to the bus 701 to obtain instructions for execution and process information stored in, for example, the memory 705. In some embodiments, the processor 703 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 703. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 703 performs a set of operations on information as specified by a set of instructions stored in memory 705 related to selectively monitor and display one or more KPI values. The execution of the instructions causes the processor to perform specified functions.

The processor 703 and accompanying components are connected to the memory 705 via the bus 701. The memory 705 includes one or more of dynamic memory (e.g., RAM, magnetic disk, writable optical disk, etc.) and static memory (e.g., ROM, CD-ROM, etc.) for storing executable instructions that when executed perform the steps described herein to selectively monitor and display one or more KPI values. The memory 705 also stores the data associated with or generated by the execution of the steps.

In one or more embodiments, the memory 705, such as a random-access memory (RAM) or any other dynamic storage device, stores information including processor instructions for selective monitoring and displaying of one or more KPI values. Dynamic memory allows information stored therein to be changed. RAM allows a unit of information stored at a location called a memory address to be stored and retrieved independently of information at neighboring addresses. The memory 705 is also used by the processor 703 to store temporary values during execution of processor instructions. In various embodiments, the memory 705 is a read only memory (ROM) or any other static storage device coupled to the bus 701 for storing static information, including instructions, that is not capable of being changed by processor 703. Some memory is composed of volatile storage that loses the information stored thereon when power is lost. In some embodiments, the memory 705 is a non-volatile (persistent) storage device, such as a magnetic disk, optical disk or flash card, for storing information, including instructions, that persists even when the system 700 is turned off or otherwise loses power.

The term “computer-readable medium” as used herein refers to any medium that participates in providing information to processor 703, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to method comprising processing, by a processor, a selection to add one or more key performance indicators (KPIs) associated with monitoring a communication network to a KPI monitoring watchlist. The method also comprises retrieving a KPI value for each of the one or more KPIs added to the KPI monitoring watchlist from a central data repository. The method further comprises causing the KPI monitoring watchlist to be output to a display such that the KPI value for each of the one or more KPIs added to the KPI monitoring watchlist is arranged in a table having columns and rows. Each of the one or more KPIs added to the KPI monitoring watchlist is arranged in one of the rows in the table. The KPI value for each of the one or more KPIs added to the KPI monitoring watchlist is in a corresponding row of the table under a header corresponding to a time at which the KPI value corresponds to an operating status of the communication network. The method additionally comprises comparing the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold. The method also comprises causing the KPI value for each of the one or more KPIs added to the KPI monitoring watchlist to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold.

Another aspect of this description is related to an apparatus comprising a processor and a memory. The memory has instructions stored thereon that, when executed by the processor, cause the apparatus to process a selection to add one or more key performance indicators (KPIs) associated with monitoring a communication network to a KPI monitoring watchlist. The apparatus is also caused to retrieve a KPI value for each of the one or more KPIs added to the KPI monitoring watchlist from a central data repository. The apparatus is further caused to cause the KPI monitoring watchlist to be output to a display such that the KPI value for each of the one or more KPIs added to the KPI monitoring watchlist is arranged in a table having columns and rows. Each of the one or more KPIs added to the KPI monitoring watchlist is arranged in one of the rows in the table. The KPI value for each of the one or more KPIs added to the KPI monitoring watchlist is in a corresponding row of the table under a header corresponding to a time at which the KPI value corresponds to an operating status of the communication network The apparatus is additionally caused to compare the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold. The apparatus is also caused to cause the KPI value for each of the one or more KPIs added to the KPI monitoring watchlist to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold.

Another aspect of this description is related to a non-transitory computer readable having instructions stored thereon that, when executed by the processor, cause an apparatus to process a selection to add one or more key performance indicators (KPIs) associated with monitoring a communication network to a KPI monitoring watchlist. The apparatus is also caused to retrieve a KPI value for each of the one or more KPIs added to the KPI monitoring watchlist from a central data repository. The apparatus is further caused to cause the KPI monitoring watchlist to be output to a display such that the KPI value for each of the one or more KPIs added to the KPI monitoring watchlist is arranged in a table having columns and rows. Each of the one or more KPIs added to the KPI monitoring watchlist is arranged in one of the rows in the table. The KPI value for each of the one or more KPIs added to the KPI monitoring watchlist is in a corresponding row of the table under a header corresponding to a time at which the KPI value corresponds to an operating status of the communication network The apparatus is additionally caused to compare the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold. The apparatus is also caused to cause the KPI value for each of the one or more KPIs added to the KPI monitoring watchlist to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
processing, by a processor, a selection to add one or more key performance indicators (KPIs) associated with monitoring a communication network to a KPI monitoring watchlist,
retrieving a KPI value for each of the one or more KPIs added to the KPI monitoring watchlist from a central data repository;
causing the KPI monitoring watchlist to be output to a display such that the KPI value for each of the one or more KPIs added to the KPI monitoring watchlist is arranged in a table having columns and rows, each of the one or more KPIs added to the KPI monitoring watchlist is arranged in one of the rows in the table, and the KPI value for each of the one or more KPIs added to the KPI monitoring watchlist is in a corresponding row of the table under a header corresponding to a time at which the KPI value corresponds to an operating status of the communication network;
comparing the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold; and
causing the KPI value for each of the one or more KPIs added to the KPI monitoring watchlist to be highlighted in the display of the KPI monitoring watchlist by one of a first color or a second color, based on a user-preference indicating which of the first color or the second color corresponds to the relationship between the KPI value for each of the one or more KPIs added to the KPI monitoring watchlist and each preset threshold.

2. The method of claim 1, wherein the relationship is one of greater than or less than, and the first color and the second color facilitate a visual representation of the relationship between the KPI value for each of the one or more KPIs added to the KPI monitoring watchlist and each preset threshold at the time indicated in the header of the KPI monitoring watchlist such that the first color corresponds to the relationship being greater than and the second color corresponds to the relationship being less than.

3. The method of claim 1, wherein the relationship between the KPI value for each of the one or more KPIs added to the KPI monitoring watchlist and each preset threshold is based on a first user input received by way of a graphical user interface defining the relationship with respect to each corresponding preset threshold and a second user input indicating the first color corresponding to the relationship.

4. The method of claim 1, wherein
the relationship is one of a first relationship or a second relationship,
the first relationship is defined by a first user input received by way of a graphical user interface, and the second relationship is defined by a second user input received by way of the graphical user interface,
the first color is selected by a third user input received by way of the graphical user interface, and the second color is selected by a fourth user input received by way of the graphical user interface, and
the first color corresponds to the first relationship, and the second color corresponds to the second relationship.

5. The method of claim 4, wherein the first relationship is a range encompassing values greater than and less than a corresponding preset threshold, and the second relationship is greater than a high end of the range.

6. The method of claim 5, further comprising:
processing an instruction to add a third relationship capable of being determined based on the comparison, the instruction to add the third relationship being received by way of a fifth user input received by way of the graphical user interface;
processing a sixth user input received by way of the user graphical user interface to select a third color corresponding to the third relationship, wherein the third relationship is different from the first relationship and the second relationship; and
causing a user profile to be generated based on the user inputs received defining the relationships and the corresponding colors.

7. The method of claim 1, further comprising:
retrieving two or more KPI values for each of the one or more KPIs added to the KPI monitoring watchlist from the central data repository, the two or more KPI values comprising at least one historical KPI value corresponding to a prior time at which the at least one KPI value corresponds to the operating status of the communication network and a most recent KPI value corresponding to the operating status of the communication network; and
causing the two or more KPI values for each of the one or more KPIs added to the KPI monitoring watchlist to be included in the KPI monitoring watchlist according to the times at which the two or more KPI values correspond to the operating status of the communication network.

8. The method of claim 1, wherein two or more KPIs are added to the KPI monitoring watchlist, each of the two of more KPIs have identical relationships and first color and second color color correspondences, and each of the two of more KPIs have different preset thresholds.

9. The method of claim 1, wherein two or more KPIs are added to the KPI monitoring watchlist, each of the two of more KPIs have different relationships and first color and second color correspondences, and each of the two of more KPIs have different preset thresholds.

10. The method of claim 1, wherein the communication network is continuously monitored such that KPI values for the one or more KPIs are added to the KPI monitoring watchlist as time progresses from a start time to an end time, and the relationship for each KPI value included in the KPI monitoring watchlist is compared to each preset threshold and the relationship is identified in the KPI monitoring watchlist for each KPI value at each time by way of the first color or the second color.

11. An apparatus, comprising:
a processor; and
a memory having instructions stored thereon that, when executed by the processor, cause the apparatus to:
process a selection to add one or more key performance indicators (KPIs) associated with monitoring a communication network to a KPI monitoring watchlist,
retrieve a KPI value for each of the one or more KPIs added to the KPI monitoring watchlist from a central data repository;
cause the KPI monitoring watchlist to be output to a display such that the KPI value for each of the one or more KPIs added to the KPI monitoring watchlist is arranged in a table having columns and rows, each of the one or more KPIs added to the KPI monitoring watchlist is arranged in one of the rows in the table, and the KPI value for each of the one or more KPIs added to the KPI monitoring watchlist is in a corresponding row of the table under a header corresponding to a time at which the KPI value corresponds to an operating status of the communication network;
compare the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold; and
cause the KPI value for each of the one or more KPIs added to the KPI monitoring watchlist to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold.

12. The apparatus of claim 11, wherein the relationship is one of greater than or less than, and the first color and the second color facilitate a visual representation of the relationship between the KPI value for each of the one or more KPIs added to the KPI monitoring watchlist and each preset threshold at the time indicated in the header of the KPI monitoring watchlist such that the first color corresponds to the relationship being greater than and the second color corresponds to the relationship being less than.

13. The apparatus of claim 11, wherein the relationship between the KPI value for each of the one or more KPIs added to the KPI monitoring watchlist and each preset threshold is based on a first user input received by way of a graphical user interface defining the relationship with respect to each corresponding preset threshold and a second user input indicating the first color corresponding to the relationship.

14. The apparatus of claim 11, wherein
the relationship is one of a first relationship or a second relationship,
the first relationship is defined by a first user input received by way of a graphical user interface, and the second relationship is defined by a second user input received by way of the graphical user interface,
the first color is selected by a third user input received by way of the graphical user interface, the second color is selected by a fourth user input received by way of the graphical user interface, and
the first color corresponds to the first relationship, and the second color corresponds to the second relationship.

15. The apparatus of claim 14, wherein the first relationship is a range encompassing values greater than and less than a corresponding preset threshold, and the second relationship is greater than a high end of the range.

16. The apparatus of claim 11, wherein the apparatus is further caused to:
retrieve two or more KPI values for each of the one or more KPIs added to the KPI monitoring watchlist from the central data repository, the two or more KPI values comprising at least one historical KPI value corresponding to a prior time at which the at least one KPI value corresponds to the operating status of the communication network and a most recent KPI value corresponding to the operating status of the communication network; and
cause the two or more KPI values for each of the one or more KPIs added to the KPI monitoring watchlist to be included in the KPI monitoring watchlist according to the times at which the two or more KPI values correspond to the operating status of the communication network.

17. The apparatus of claim 11, wherein two or more KPIs are added to the KPI monitoring watchlist, each of the two of more KPIs have identical relationships and first color and second color correspondences, and each of the two of more KPIs have different preset thresholds.

18. The apparatus of claim 11, wherein two or more KPIs are added to the KPI monitoring watchlist, each of the two of more KPIs have different relationships and first color and second color correspondences, and each of the two of more KPIs have different preset thresholds.

19. The apparatus of claim 11, wherein the communication network is continuously monitored such that KPI values for the one or more KPIs are added to the KPI monitoring watchlist as time progresses from a start time to an end time, and the relationship for each KPI value included in the KPI monitoring watchlist is compared to each preset threshold and the relationship is identified in the KPI monitoring watchlist for each KPI value at each time by way of the first color or the second color.

20. A non-transitory computer readable medium having instructions stored thereon that, when executed by a processor, cause an apparatus to:
process a selection to add one or more key performance indicators (KPIs) associated with monitoring a communication network to a KPI monitoring watchlist,
retrieve a KPI value for each of the one or more KPIs added to the KPI monitoring watchlist from a central data repository;
cause the KPI monitoring watchlist to be output to a display such that the KPI value for each of the one or more KPIs added to the KPI monitoring watchlist is arranged in a table having columns and rows, each of the one or more KPIs added to the KPI monitoring watchlist is arranged in one of the rows in the table, and the KPI value for each of the one or more KPIs added to the KPI monitoring watchlist is in a corresponding row of the table under a header corresponding to a time at which the KPI value corresponds to an operating status of the communication network;
compare the KPI value for each of the one or more KPIs added to the KPI monitoring watchlist to a preset threshold corresponding to each of the one or more KPIs added to the KPI monitoring watching to determine a relationship between the KPI value for each of the one or more KPIs added to the KPI monitoring watchlist and each preset threshold; and
cause the KPI value for each of the one or more KPIs added to the KPI monitoring watchlist to be highlighted in the display of the KPI monitoring watchlist by one of a first color or a second color based on a user-preference indicating which of the first color or the second color corresponds to the relationship between the KPI value for each of the one or more KPIs added to the KPI monitoring watchlist and each preset threshold,
and output to a display based on the one or more hierarchy selection inputs.
